(19) United States
(12) Patent Application Publication
(10) Pub. No.: US 2007/0215228 A1
(43) Pub. Date: Sep. 20, 2007

(54) PRE-CONDITIONED AIR CONDUIT FORMED FROM CONTINUOUS STRIP

(75) Inventors: Anatoly Gosis, Palatine, IL (US); Scott Takayuki Koizumi, Fairfield, CA (US); Folkert Fred Koch, San Ramon, CA (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 11/681,602

(22) Filed: Mar. 2, 2007

Related U.S. Application Data
(60) Provisional application No. 60/781,841, filed on Mar. 13, 2006.

(51) Int. Cl. F16L 11/00

(52) U.S. Cl. 138/129; 138/154; 138/162; 138/163

(57) ABSTRACT

A tubular fluid conduit, for conducting pre-conditioned air to an aircraft, is fabricated from a single, continuous strip of material which has a predetermined width dimension and first and second fasteners disposed upon the oppositely disposed longitudinally extending side edge portions of the strip of material. The strip of material is coiled in a spiral manner into a tubular configuration along its longitudinal length, and the first and second fasteners, disposed upon adjacent edge portions of sequentially coiled sections of the tubular conduit, are mated with each other so as to fasten together the sequentially coiled sections of the tubular conduit. The tubular conduit may have any predetermined length dimension, depending upon the number of sequentially coiled sections that are formed, and may also have any predetermined diametrical extent depending upon the size and configuration of the sequentially coiled sections.

### CROSS REFERENCE TO RELATED APPLICATION

This application claims priority to U.S. Provisional Application No. 60/781,841, filed on Mar. 13, 2006, which is hereby incorporated by reference.

### FIELD OF THE INVENTION

The present invention relates generally to fluid conduits, and more particularly to a new and improved tubular fluid conduit which is especially adapted for use in supplying pre-conditioned air to an aircraft while, for example, the aircraft is located upon the ground and being serviced, during which time the aircraft is unable to generate its own supply of conditioned air for the crew and passengers, wherein the tubular conduit is fabricated from a single, continuous strip or sheet of material having a predetermined width dimension, and having first and second fasteners respectively and continuously disposed upon or secured to oppositely disposed longitudinally extending side edge portions of the continuous strip or sheet of material, such that when the single, continuous strip or sheet of material is effectively continuously coiled into a tubular configuration, in accordance with spiral coiling or wrapping techniques, utilizing, for example, a suitable mandrel having a predetermined diametrical size and configuration, so as to form the tubular conduit, the first and second fasteners, disposed upon or secured to the adjacent edge portions of sequentially or serially coiled or wrapped sections of the tubular conduit, will be able to be mated with each other so as to securely fasten together the adjacent edge portions of the sequentially or serially coiled or wrapped sections of the tubular conduit in an airtight manner. The tubular conduit may have any predetermined length dimension depending upon the number of serially or sequentially coiled or wrapped sections of the tubular conduit that are formed and fastened together, it may also have any predetermined diametrical extent depending upon, for example, the size and configuration of the mandrel around which the strip or sheet of material is coiled or wrapped, and it is also capable of being easily and rapidly deployed and stowed, as well as being capable of being stored in a relatively compact state.

### BACKGROUND OF THE INVENTION

When an aircraft is located upon the ground and is being serviced, various services are required to be supplied to the aircraft, such as, for example, electrical power, pre-conditioned air, and the like. In connection with the provision of the pre-conditioned air to the aircraft, a suitable heating/air-conditioning unit is used, and accordingly, a first end portion of the tubular supply conduit is fluidically connected in an airtight manner to the heating/air-conditioning unit while a second end portion of the tubular supply conduit is fluidically connected in an airtight manner to a suitable air inlet port located on board the aircraft. The tubular conduit must be able to perform and remain flexible under various weather or environmental conditions, such as, for example, hot temperatures, cold temperatures, dry atmospheric conditions, humid atmospheric conditions, rain, snow, ice, and the like, and it must be capable of satisfying various operational parameters. For example, the tubular conduit must be rugged and durable in view of the fact that it is often moved or dragged over the various regions of the tarmac or the ground areas surrounding the airport terminal. In addition, the tubular conduit must be capable of being easily and rapidly deployed, easily and rapidly stowed, and capable of being stored in a relatively compact state. Still yet further, it is necessary that such tubular fluid conduits be capable of being easily and readily fabricated so as to comprise various or different predetermined length dimensions.

Various means or methods of fabricating such tubular fluid conduits, having such different length dimensions, have been previously proposed, however, such conventional, PRIOR ART tubular fluid conduits are all basically or substantially similar in that separate tubular fluid conduit sections are adapted to be mated and secured together by means of various different fasteners. Examples of such conventional, PRIOR ART tubular fluid conduit systems, and the techniques for fabricating the same, are disclosed, for example, within U.S. Pat. No. 6,443,499 which issued to Jenum on Sep. 3, 2002, U.S. Pat. No. 6,286,876 which issued to Jasperse et al. on Sep. 11, 2001, and U.S. Pat. No. 5,368,341 which issued to Larson on Nov. 29, 1994. As can be readily appreciated from such PRIOR ART patents, separate adjacent sections of the overall tubular fluid conduit are attached together by means of, for example, zipper type fasteners, VELCRO® fasteners, and the like. It can be further appreciated, however, that these fabrication techniques are quite time consuming and tedious in that each separate section of the tubular fluid conduit must be handled and positioned with respect to the previously positioned or connected section of the tubular fluid conduit, and then in addition, each pair of adjacent, cooperating fasteners, disposed upon the newly added section of the tubular fluid conduit, and the previously connected section of the tubular fluid conduit, must be mated and connected together. Still yet further, it is noted that each section of such conventional, PRIOR ART tubular fluid conduits has a predetermined, constant diametrical extent, and therefore, such tubular fluid conduit sections can only be utilized in connection with the fabrication of a tubular fluid conduit or assembly having a predetermined constant diametrical extent.

Accordingly, there is a need in the art for a new and improved tubular conduit which can be easily and rapidly deployed, which can be easily and rapidly stowed, which can be stored in a relatively compact state, and which can have any predetermined length or diametrical dimension, and yet, the tubular fluid conduit is not to be fabricated from separate tubular sections but, to the contrary, is to be fabricated from a single, continuous strip or sheet of material having a predetermined width dimension.

### SUMMARY OF THE INVENTION

The foregoing and other objectives are achieved in accordance with the teachings and principles of the present invention through the provision of a new and improved tubular conduit which is adapted to be fabricated from a single, continuous strip or sheet of material. The single, continuous strip or sheet of material has a predetermined width dimension, and in addition, has first and second fasteners that are respectively and continuously disposed upon or secured to the oppositely disposed longitudinally extending side edge portions of the continuous strip or sheet of material.

The single, continuous strip or sheet of material is adapted to be coiled in a spiral manner along its longitudinal length, and in this manner, when the single, continuous strip or sheet of material is effectively continuously coiled into a tubular configuration so as to form the tubular conduit, the first and second fasteners, disposed upon or secured to the adjacent edge portions of serially or sequentially coiled sections of the tubular conduit, will be able to be mated with each other so as to securely fasten together the adjacent edge portions of the sequentially or serially coiled sections of the tubular conduit in an airtight manner. The tubular conduit may have any predetermined length dimension depending upon the number of sequentially or serially coiled or wrapped sections of the tubular conduit that are formed and fastened together, and may also have any predetermined diametrical extent depending upon, for example, the size and configuration of the mandrel around which the strip or sheet of material is coiled or wrapped. The tubular conduit can likewise be easily and rapidly deployed and stowed, and is also capable of being stored in a relatively compact state.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective schematic view of a single continuous strip or sheet of material from which the new and improved tubular fluid conduit, constructed in accordance with the principles and teachings of the present invention, is to be fabricated by coiling the same substantially in the direction of the longitudinal axis of the single continuous strip or sheet of material;

FIG. 2 is a perspective view of a first embodiment of a new and improved tubular fluid conduit which has been constructed, in accordance with the teachings and principles of the present invention, from the single continuous strip or sheet of material as illustrated within FIG. 1 as a result of coiling the single continuous strip or sheet of material substantially in the direction of the longitudinal axis of the single continuous strip or sheet of material;

FIG. 3 is a cross-sectional view of the single continuous strip or sheet of material as illustrated within FIG. 1, and as taken along the lines 3-3 of FIG. 1, showing the details of first embodiment fasteners that have been fixedly secured along the oppositely disposed longitudinally extending edge portions of the single continuous strip or sheet of material as illustrated within FIG. 1 so as to secure together adjacent pairs of oppositely disposed longitudinally extending edge portions of the single continuous strip or sheet of material when the single continuous strip or sheet of material has been coiled into the tubular fluid conduit;

FIG. 4 is a schematic side elevational view illustrating a second embodiment of a new and improved tubular fluid conduit which can be constructed in accordance with the principles and teachings of the present invention;

FIG. 5 is an exploded cross-sectional view showing second embodiment fasteners which can be utilized to secure together oppositely disposed, longitudinally extending side edge portions of adjacent coiled sections of the new and improved tubular conduit of the present invention;

FIG. 6 is a cross-sectional view of the oppositely disposed, longitudinally extending side edge portions of the adjacent coiled sections of the new and improved tubular conduit of the present invention, as illustrated within FIG. 5, as they will appear once the second embodiment fasteners, as illustrated within FIG. 5, are assembled together;

FIG. 7 is a cross-sectional view showing the second embodiment fasteners, as illustrated within FIG. 5, after they have been assembled together so as to securely fasten together the oppositely disposed, longitudinally extending side edge portions of adjacent coiled sections of the new and improved tubular conduit of the present invention in the manner illustrated within FIG. 6;

FIG. 8 is an exploded cross-sectional view, similar to that of FIG. 5, showing, however, third embodiment fasteners which can likewise be utilized to secure together oppositely disposed, longitudinally extending side edge portions of adjacent coiled sections of the new and improved tubular conduit of the present invention;

FIG. 9 is a cross-sectional view, similar to that of FIG. 6, showing, however, the oppositely disposed, longitudinally extending side edge portions of the adjacent coiled sections of the new and improved tubular conduit of the present invention, as illustrated within FIG. 8, as they will appear once the third embodiment fasteners, as illustrated within FIG. 8, are assembled together;

FIG. 10 is a cross-sectional view, similar to that of FIG. 7, showing, however, the third embodiment fasteners, as illustrated within FIG. 8, after they have been assembled together so as to securely fasten together the oppositely disposed, longitudinally extending side edge portions of adjacent coiled sections of the new and improved tubular conduit of the present invention in the manner illustrated within FIG. 9;

FIG. 11 is a cross-sectional view showing fourth embodiment fasteners which can likewise be utilized to secure together oppositely disposed, longitudinally extending side edge portions of adjacent coiled sections of the new and improved tubular conduit of the present invention;

FIG. 12 is a cross-sectional view showing fifth embodiment fasteners which can likewise be utilized to secure together oppositely disposed, longitudinally extending side edge portions of adjacent coiled sections of the new and improved tubular conduit of the present invention;

FIG. 13 is a schematic top plan view of a tubular conduit having a sixth embodiment zipper-type fastener incorporated therein for securing together oppositely disposed, longitudinally extending side edge portions of adjacent coiled sections of the new and improved tubular conduit of the present invention;

FIG. 14 is a cross-sectional view of a tubular conduit having a seventh embodiment VELCRO®type fastener incorporated therein for securing together oppositely disposed, longitudinally extending side edge portions of adjacent coiled sections of the new and improved tubular conduit of the present invention;

FIG. 15 is a cross-sectional view of a tubular conduit having an eighth embodiment glue or adhesive-type fastener incorporated therein for securing together oppositely disposed, longitudinally extending side edge portions of adjacent coiled sections of the new and improved tubular conduit of the present invention; and

FIG. 16 is a cross-sectional view of a tubular conduit having a ninth embodiment stitching-type fastener incorporated therein for securing together oppositely disposed, longitudinally extending side edge portions of adjacent coiled sections of the new and improved tubular conduit of the present invention.

### DETAILED DESCRIPTION OF THE ILLUSTRATED EMBODIMENTS

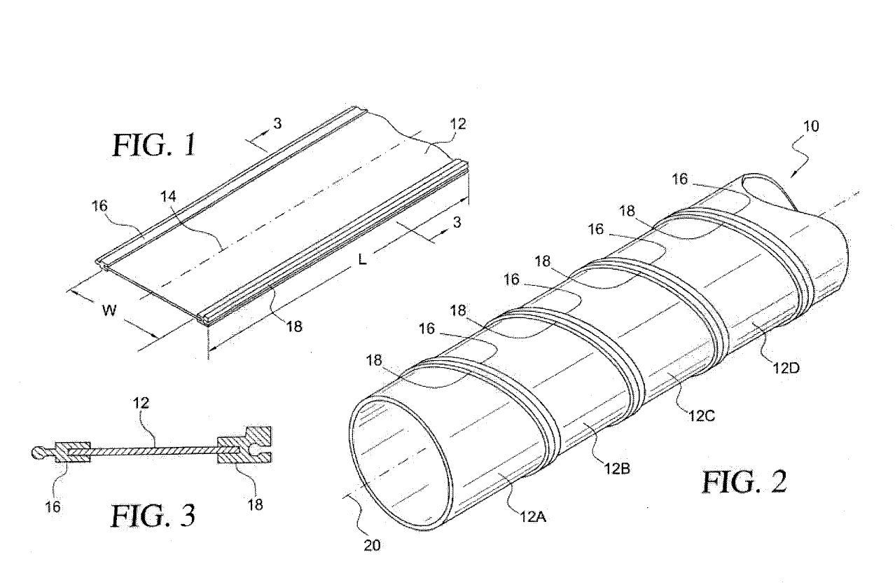

Referring now to the drawings, and more particularly to FIGS. 1-3 thereof, a first embodiment of a new and improved tubular fluid conduit, which has been constructed in accordance with the principles and teachings of the present invention, is disclosed and is generally indicated by the reference character 10 in FIG. 2. More particularly, with reference initially being directed to FIG. 1, a single continuous strip or sheet 12, from which the new and improved tubular fluid conduit 10 is to be fabricated, is preferably formed from a material which is rugged, durable, and impervious to air. In this manner, the material is especially useful in connection with the fabrication of a tubular fluid conduit which may in fact serve as an airflow conduit to be used in connection with the supply or provision of pre-conditioned air to an aircraft when the aircraft is on the ground and being serviced. A suitable material, which meets or satisfies the previous parameters and necessary functional characteristics, may comprise a material similar to or selected from that family of materials of which GORETEX® is a representative example. Continuing further, the single continuous strip or sheet 12 can have any selectable predetermined length dimension L, as may be desired or required in connection with the fabrication of a particular one of the new and improved tubular fluid conduit 10, and as is defined along its longitudinal extent or axis 14, and in addition, the single continuous strip or sheet 12 can also have any selectable predetermined width dimension W as may likewise be desired or required new and improved tubular fluid conduit 10. Lastly, as can be generally appreciated from FIG. 1, and as can be specifically appreciated from the detailed cross-sectional view of FIG. 3, the pair of oppositely disposed longitudinally extending side edge portions of the single continuous strip or sheet 12 have first and second fasteners 16, 18 respectively fixedly secured thereto. In particular, it is seen that the first and second fasteners 16, 18 respectively comprise snap-in engagement type male and female fasteners.

In accordance with the fabrication techniques characteristic of the present invention, and in connection with the actual formation of the new and improved tubular fluid conduit 10 as illustrated within FIG. 2, the single continuous strip or sheet 12 is adapted to be spirally coiled, wound, or wrapped, substantially in a direction parallel to its longitudinal axis 14, around, for example, a suitable, predeterminedly sized and configured mandrel, not shown, such that successive, sequential, or serially coiled or wrapped sections 12A, 12B, 12C, 12D of the single continuous strip or sheet 12 will be disposed immediately adjacent to each other. In this manner, it can be further appreciated as a result of the aforenoted coiling, winding, or wrapping of the single, continuous strip or sheet 12 around the suitable, predeterminedly sized and configured mandrel, not shown, and as a result of the adjacent disposition of the successively, sequentially, or serially coiled or wrapped sections 12A, 12B, 12C, 12D of the single continuous strip or sheet 12 with respect to each other, then the male fastener 16 of a successive one of the sections 12A, 12B, 12C, 12D of the single continuous strip or sheet 12 will always be disposed adjacent to a female fastener 18 of the previous one of the sections 12A, 12B, 12C, 12D of the single continuous strip or sheet 12. Accordingly, the adjacent pairs of male and female fasteners 16, 18 can be continuously mated together along their respective longitudinal extents, and in the direction substantially parallel to the longitudinal axis or extent 14 of the single, continuous strip or sheet 12, so as to in fact fixedly secure together the plurality of sections 12A, 12B, 12C, 12D of the single continuous strip or sheet 12 in an airtight manner.

It is to be further appreciated that in accordance with the fabrication techniques characteristic of the present invention in connection with the formation of the new and improved tubular fluid conduit 10, the length of the finalized tubular fluid conduit 10 can be substantially any length as may be desired or required in accordance with the particular usage or application requirements depending upon the number of sections, such as, for example, the plurality of sections 12A, 12B, 12C, 12D of the single continuous strip or sheet 12, that are coiled, wound, or wrapped around the forming mandrel, as well as the width dimension W of the original single continuous strip or sheet 12. For example, if the width dimension W of the original single continuous strip or sheet 12 is two feet (2.00′) wide, then the axial length of each coiled, wound, or wrapped section 12A, 12B, 12C, 12D of the tubular fluid conduit 10, as considered along the longitudinal or axial extent of the tubular fluid conduit 10 as defined by means of its longitudinal axis 20, would be approximately two feet (2.00′), and if fifty sections of the single, continuous strip or sheet 12, similar to the sections 12A, 12B, 12C, 12D of the single, continuous strip or sheet 12 as illustrated within FIG. 2, were serially, successively, or sequentially coiled, wound, or wrapped around, for example, the forming mandrel and subsequently mated together, by means of the cooperating fasteners 16, 18, in order to form the finalized tubular fluid conduit 10, then the finalized tubular fluid conduit 10 would have a finalized length dimension of approximately one hundred feet (100′).

It can likewise be appreciated that the diametrical extent of the finalized tubular fluid conduit 10 can similarly be substantially any dimension as may be required or desired depending upon the diametrical extent or dimension of, for example, the particular forming mandrel, not shown, which is employed and around which the single, continuous strip or sheet of material 12 is coiled, wound, or wrapped. Still yet further, it can also be appreciated that depending upon the particular geometrical configuration of the particular mandrel employed in connection with the coiling, winding, or wrapping of the single, continuous strip or sheet 12 there around in order to serially, successively, or sequentially form the sections 12A, 12B, 12C, 12D of the finalized tubular flow conduit 10, the diametrical extent of the finalized tubular flow conduit 10 can be substantially constant throughout its entire longitudinal extent, or alternatively, the diametrical extent of the finalized tubular flow conduit 10 can, for example, vary from one end of the finalized tubular flow conduit 10 to the other opposite end of the conduit 10. In particular, for example, the finalized tubular flow conduit 10 as illustrated within FIG. 2 was formed upon a mandrel, not shown, which had a substantially cylindrical configuration.

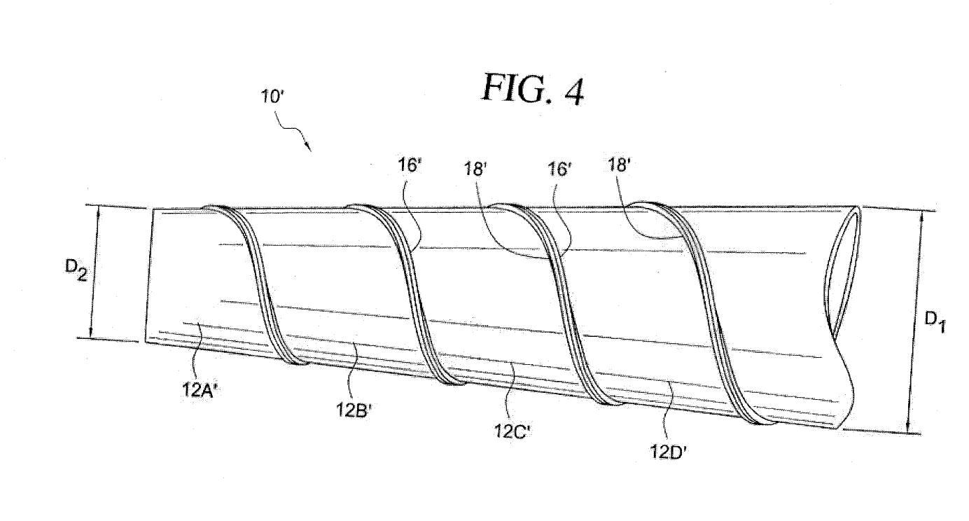

Alternatively, a finalized tubular flow conduit 10′, as illustrated within FIG. 4, wherein all of the component parts thereof, corresponding to the component parts of the tubular flow conduit 10 illustrated within FIG. 1, are substantially the same and so have simply been denoted by means of a (′), can be formed upon a mandrel, not shown, which has a substantially frustoconical configuration whereby the diametrical extent of the finalized tubular flow conduit 10′ will, for example, have a tapered configuration wherein one end of the finalized tubular flow conduit 10′ will be characterized by means of a relatively large diameter dimension D₁ while the other opposite end of the finalized tubular flow conduit 10′ will be characterized by means of a relatively small diameter dimension D₂. Such a tapered airflow conduit 10′ finds particular usage as a airflow conduit for supplying pre-conditioned air to an aircraft, while the aircraft is being serviced, because it is often the case that the upstream end portion of the conduit 10′ that is connected to the heating/air-conditioning supply unit needs to be, for example, fourteen inches (14″) in diameter in order to be readily fluidically connected to the heating/air-conditioning supply unit, while the oppositely disposed downstream end portion of the conduit 10′ that is to be connected to the aircraft inlet port needs to be, for example, only eight inches (8″) in diameter.

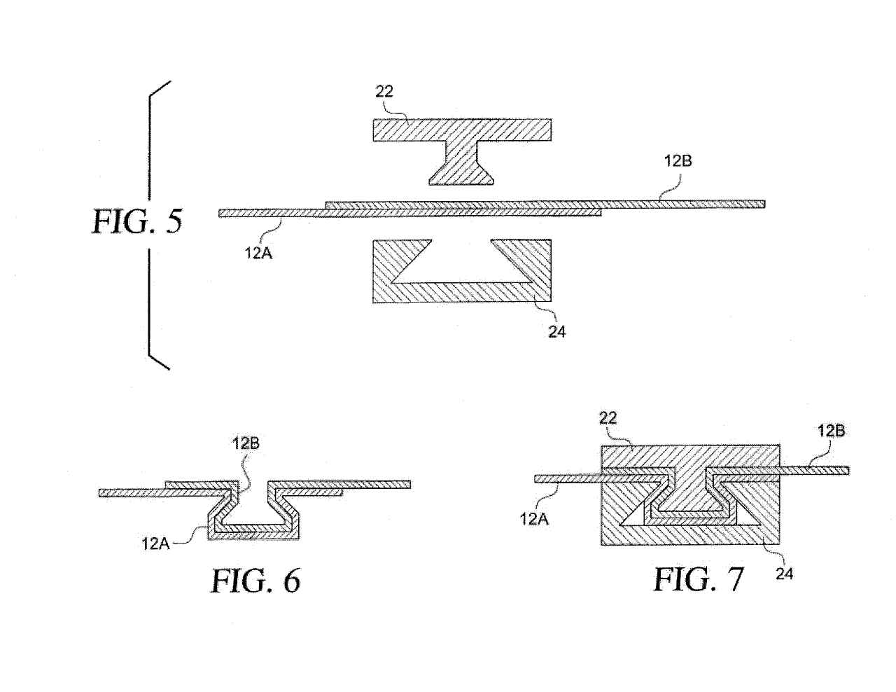

With reference now being made to FIGS. 5-7, second embodiment fasteners, which can be utilized to secure together the oppositely disposed, longitudinally extending side edge portions of adjacent spirally coiled, wound, or wrapped sections of the new and improved tubular conduit of the present invention, are respectively disclosed at 22, 24. More particularly, in accordance with the principles and teachings characteristic of the second embodiment fasteners 22, 24, it is initially seen that, unlike the first embodiment fasteners 16, 18 as disclosed within FIGS. 1-3, the second embodiment fasteners 22, 24 are not fixedly secured upon the oppositely disposed longitudinally extending side edge portions of the single continuous strip or sheet 12, but to the contrary, the second embodiment fasteners 22, 24 comprise fastening components which are separate from the single continuous strip or sheet 12 and which are adapted to be fastened together so as to effectively secure together the oppositely disposed longitudinally extending side edge portions, of adjacent spirally coiled, wound, or wrapped sections of the single continuous strip or sheet 12, when the second embodiment fasteners 22, 24 are mated together. The second embodiment fasteners 22, 24 effectively define a dovetail joint when they are mated together, with the fastener member 22 comprising a male tenon type dovetail fastener, while the fastener member 24 comprises a female mortise type dovetail fastener.

It is also appreciated that when the oppositely disposed, longitudinally extending side edge portions of the adjacent sections, such as, for example, sections 12A and 12B, of the single continuous strip or sheet 12 are to be secured together in accordance with the principles and teachings of the present invention utilizing the second embodiment fasteners 22, 24, the oppositely disposed, longitudinally extending side edge portions of the adjacent sections 12A, 12B of the single continuous strip or sheet 12 are initially overlapped with respect to each other and are also interposed between the second embodiment fasteners 22, 24 in that the second embodiment fasteners 22, 24 are disposed upon opposite sides of the oppositely disposed, longitudinally extending side edge portions of the adjacent sections 12A, 12B of the single continuous strip or sheet 12 as illustrated within FIG. 5. Subsequently, when the second embodiment fasteners 22, 24 are in fact mated together, the oppositely disposed, longitudinally extending side edge portions of the adjacent sections 12A, 12B of the single continuous strip or sheet 12 are effectively trapped between the mated second embodiment fasteners 22, 24 as can best be seen from FIG. 7, wherein the overlapped oppositely disposed, longitudinally extending side edge portions of the adjacent sections 12A, 12B of the single continuous strip or sheet 12 achieve the finalized configuration that is also illustrated within FIG. 6.

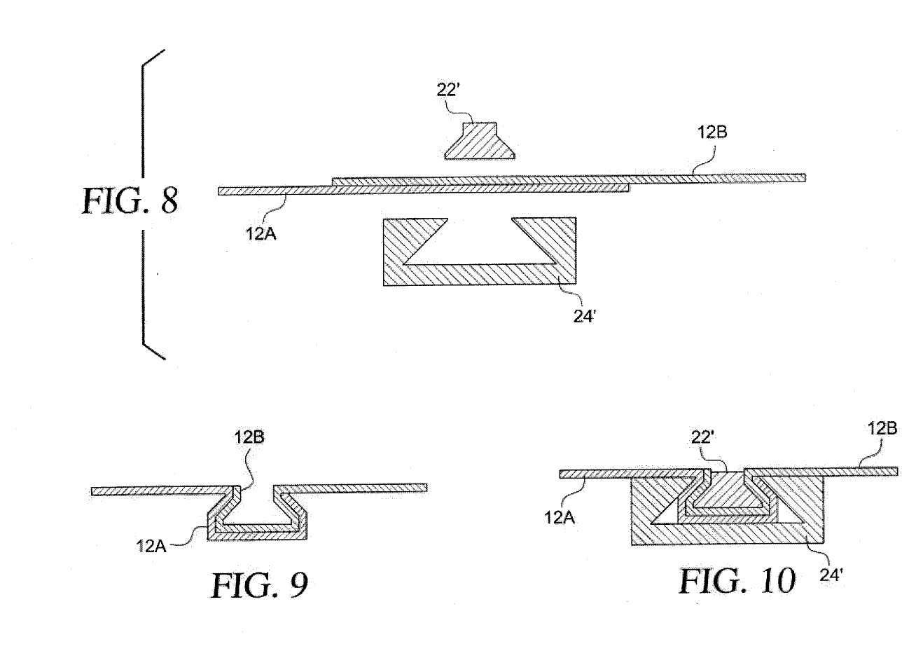

With reference now being made to FIGS. 8-10, third embodiment fasteners, which can likewise be utilized to secure together the oppositely disposed, longitudinally extending side edge portions of adjacent spirally coiled, wrapped, or wound sections of the new and improved tubular conduit of the present invention, are respectively disclosed and have been designated by the reference characters 22′, 24′ in view of the similarity of the third embodiment fasteners 22′, 24′ to the second embodiment fasteners 22, 24. Accordingly, a full discussion of the third embodiment fasteners 22′, 24′ will not be provided for brevity purposes, but only the differences between such second and third embodiment fasteners 22, 24 and 22′, 24′, as well as those characteristic of the secured assembly comprising the third embodiment fasteners 22′, 24′ along with the oppositely disposed, longitudinally extending side edge portions of the adjacent sections 12A, 12B of the single continuous strip or sheet 12, will be discussed.

More particularly, it is initially seen that, while the third embodiment fasteners 22′, 24′ effectively define a dovetail joint similar to that formed by means of the second embodiment fasteners 22, 24, it is to be appreciated that the male tenon type dovetail fastener 22′ effectively defines a plug type fastener which does not externally overlap the female type mortise dovetail fastener 24′ when the third embodiment fasteners 22′, 24′ are mated together, as was the case with the male tenon type dovetail fastener 22 with respect to the female type mortise dovetail fastener 24, but to the contrary, the male tenon type dovetail fastener 22′ will be substantially totally encapsulated within the internally recessed or channel portion of the female type mortise dovetail fastener 24′ as can best be appreciated from FIG. 10. In addition, it is also best appreciated from FIGS. 9 and 10 that, in view of the afore noted cooperating structure defined between the third embodiment fasteners 22′, 24′ when the third embodiment fasteners 22′, 24′ are mated together, the oppositely disposed, longitudinally extending side edge portions of the adjacent sections 12A, 12B of the single continuous strip or sheet 12 are overlapped with respect to each only within the internally recessed or channel portion of the female type mortise dovetail fastener 24′.

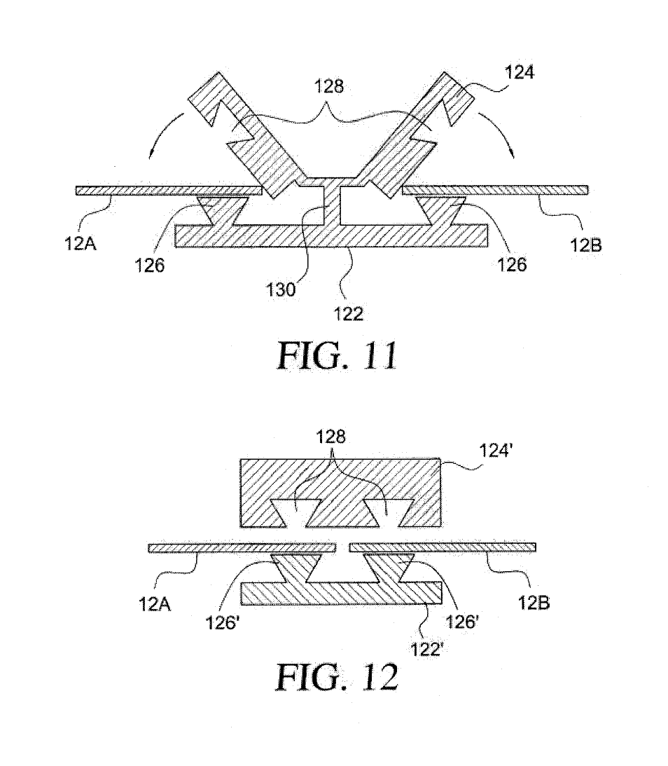

With reference now being made to FIG. 11, fourth embodiment fasteners, which can likewise be utilized to secure together the oppositely disposed, longitudinally extending side edge portions of adjacent spirally coiled, wrapped, or wound sections of the new and improved tubular conduit of the present invention, are respectively disclosed and have been designated by the reference characters 122, 124. It is initially noted that, while the fourth embodiment fasteners 122, 124 are similar to, for example, the second and third embodiment fasteners 22, 24 and 22′, 24′ in that the fourth embodiment fasteners 122, 124 are not fixedly secured upon the oppositely disposed longitudinally extending side edge portions of the single continuous strip or sheet 12, but, to the contrary, comprise fastening components which are separate from the single continuous strip or sheet 12 and which are adapted to secure together the oppositely disposed longitudinally extending side edge portions, of adjacent spirally coiled, wound, or wrapped sections 12A, 12B of the single continuous strip or sheet 12, when the second embodiment fasteners 22, 24 are mated together, it is also noted that unlike the second and third embodiment fasteners 22, 24, and 22′, 24′, the fourth embodiment fasteners 122, 124 are integrally connected together by means of a centrally located substantially T-shaped support platform 130. In addition, the entire fastener assembly is effectively interposed between the oppositely disposed longitudinally extending side edge portions, of adjacent spirally coiled, wound, or wrapped sections 12A, 12B of the single continuous strip or sheet 12, such that the oppositely disposed longitudinally extending side edge portions of adjacent spirally coiled, wound, or wrapped sections 12A, 12B of the single continuous strip or sheet 12 are not required to be overlapped with respect to each other. In this manner, it can be further appreciated that the oppositely disposed longitudinally extending side edge portions of the adjacent spirally coiled, wound, or wrapped sections 12A, 12B of the single continuous strip or sheet 12 are effectively secured together when the fourth embodiment fasteners 122, 124 are themselves secured together.

More particularly, it is seen that the male fastener 122 actually comprises a pair of longitudinally spaced male tenon type dovetail fastener members 126, 126, while the female fastener 124 similarly comprises a pair of longitudinally spaced female mortise type dovetail fastener members 128, 128 which are adapted to respectively accommodate the pair of longitudinally spaced male tenon type dovetail fastener members 126, 126. The pair of longitudinally spaced female mortise type dovetail fastener members 128, 128 are pivotally mounted upon opposite ends of the centrally located support platform 130, and when each one of the pair of longitudinally spaced female mortise type dovetail fastener members 128, 128 is pivoted so as to be respectively mated with a corresponding one of the pair of longitudinally spaced male tenon type dovetail fastener members 126, 126, the oppositely disposed longitudinally extending side edge portions, of adjacent spirally coiled, wound, or wrapped sections 12A, 12B of the single continuous strip or sheet 12 will respectively be trapped and secured between each cooperating pair of male tenon type dovetail fastener members 126, 126 and female mortise type dovetail fastener members 128, 128.

Referring now to FIG. 12, fifth embodiment fasteners are disclosed and are designated by reference characters 122′, 124′. The fifth embodiment fasteners 122′, 124′ are seen to be somewhat similar to the fourth embodiment fasteners 122, 124 in that the fifth embodiment fasteners 122′, 124′ respectively comprise a pair of longitudinally spaced male tenon type dovetail fastener members 126′, 126′ and a pair of longitudinally spaced female mortise type dovetail fastener members 128′, 128′, however, the fifth embodiment fasteners 122′, 124′ are different from the fourth embodiment fasteners 122, 124 and similar to the second embodiment fasteners 22, 24 in that they are separate from each other and are adapted to be disposed upon opposite sides of the oppositely disposed longitudinally extending side edge portions of adjacent spirally coiled, wound, or wrapped sections 12A, 12B of the single continuous strip or sheet 12.

In this manner, each cooperating pair of male and female tenon and mortise type dovetail fastener members 126′, 128′ will respectively entrap and secure one of the oppositely disposed longitudinally extending side edge portions of adjacent spirally coiled, wound, or wrapped sections 12A, 12B of the single continuous strip or sheet 12. It is lastly noted that with any one of the dovetail type fasteners as disclosed, for example, within FIGS. 5-12, while the fasteners can be disengaged from each other once they have been mated with each other, the fasteners are normally intended to remain permanently attached to each other in order to maintain the integrity of, for example, the tubular flow conduit 10 intact. In addition, it is also noted as is the normal mode of operation in connection with the mating together of the male and female tenon and mortise type dovetail fastener members, the male tenon type dovetail fastener members are not simply pushed into the female mortise type dovetail fastener members in a normal or perpendicular direction, but to the contrary, the male tenon type dovetail fastener members are usually inserted into the female mortise type dovetail fastener members in an angular direction other than normal or perpendicular.

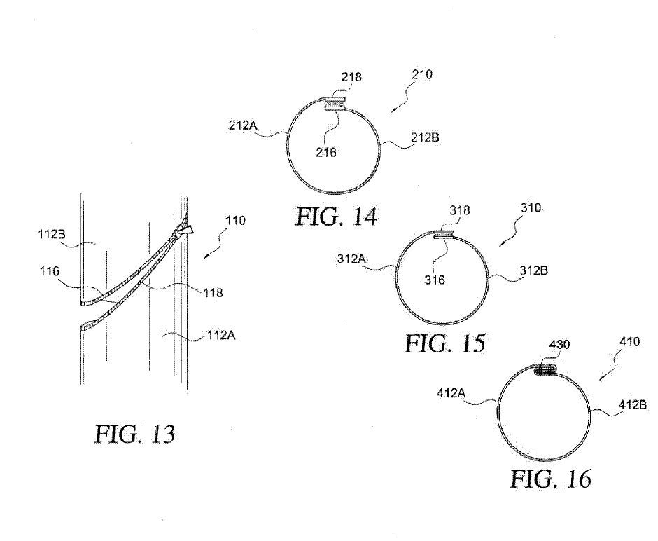

With reference lastly being made to FIGS. 13-16, while various exemplary embodiments of different structural fasteners have already been disclosed, for example, within FIGS. 3 and 5-12, still other examples of different type fasteners might be incorporated within a tubular conduit, constructed in accordance with the teachings and principles of the present invention, for securing together the oppositely disposed, longitudinally extending side edge portions of adjacent coiled sections of the new and improved tubular conduit of the present invention, More particularly, a tubular conduit, generally indicated by the reference character 110 within FIG. 13, has incorporated therein male and female zipper components 116, 118 for securing together the oppositely disposed, longitudinally extending side edge portions of adjacent coiled sections 112A, 112B of the tubular conduit 110, while in a similar manner, a tubular conduit, generally indicated by the reference character 210 within FIG. 14, has incorporated therein male and female VELCRO® components 216, 218 for securing together the oppositely disposed, longitudinally extending side edge portions of adjacent coiled sections 212A, 212B of the tubular conduit 210. Still yet further, a tubular conduit, generally indicated by the reference character 310 within FIG. 15, has incorporated therein male and female adhesive components 316, 318 for securing together the oppositely disposed, longitudinally extending side edge portions of adjacent coiled sections 312A, 312B of the tubular conduit 310, while lastly, a tubular conduit, generally indicated by the reference character 410 within FIG. 16, has incorporated therein stitching 430 for securing together the oppositely disposed, longitudinally extending side edge portions of adjacent coiled sections 412A, 412B of the tubular conduit 410.

It is also to be noted, in connection with any one of the particular embodiments of the tubular conduits 10, 10′, 110, 210, 310, 410 and the different embodiment fasteners incorporated therein, as has been disclosed within the various drawing FIGS. 1-16, that in some or most of the cases or instances in which the particular fasteners have been incorporated upon the longitudinally extending side edge portions of the various sections 12A12D, 112A, 112B, 212A, 212B, 312A, 312B, 412A, 412B of the tubular conduits 10, 10′, 110, 210, 310, 410, in order to secure together the oppositely disposed, longitudinally extending side edge portions of adjacent coiled sections 12A12D, 112A, 112B, 212A, 212B, 312A, 312B, 412A, 412B of the tubular conduits 10, 10′, 110, 210, 310, 410, the fabric material, from which the continuous strip comprising the tubular conduits 10, 10′, 110, 210, 310, 410 are fabricated, is usually disposed internally within the external or outer peripheral confines of the respective fasteners incorporated thereon, particularly those disclosed, for example, within FIGS. 1-13. It can therefore be appreciated that such fasteners effectively prevent the outer surface portions of the tubular conduit sections from being disposed in contact with the ground or tarmac areas of the airport facility, thereby, in turn, effectively preventing such fabric regions of the tubular conduit sections from being accordingly abraded.

In a similar manner, it can be noted still further, and as can best be appreciated with reference again being made to FIG. 1, that, for example, the structural assembly of the new and improved tubular fluid conduit 10, comprising the plurality of sections 12A12D which are effectively interconnected together by means of the fasteners 16, 18, renders the new and improved tubular fluid conduit 10 readily expansible or collapsible, in a mode similar to that of a spring or accordion, between an extended or deployed position, and a collapsed or stowed position. Such structure, in turn, renders the new and improved tubular fluid conduit 10 especially or uniquely adapted for compact storage of the same. More particularly, as can be best understood from FIG. 1, the tubular fluid conduit 10 is shown in its relatively expanded or deployed position, however, it can be further appreciated that when the tubular fluid conduit 10 is to be axially contracted toward its collapsed or stowed position, the plurality of fasteners 16, 18 may simply be moved toward each other such that the fluid conduit assembly 10 can achieve the most compact mode or state possible.

Thus, it may be seen that in accordance with the principles and teachings of the present invention, there has been disclosed a new and improved tubular fluid conduit which is adapted to be fabricated from a single, continuous strip or sheet of material which has a predetermined width dimension, and which is adapted to be coiled in a spiral manner along its longitudinal length. In addition, the strip or sheet of material has first and second fastener components that are respectively and continuously disposed upon or secured to the oppositely disposed longitudinally extending side edge portions of the continuous strip or sheet of material, and in this manner, when the single, continuous strip or sheet of material is effectively continuously coiled into a tubular configuration so as to form the tubular conduit, the first and second fasteners, disposed upon or secured to the adjacent edge portions of serially or sequentially coiled sections of the tubular conduit, will be able to be mated with each other so as to securely fasten together the adjacent edge portions of the sequentially or serially coiled sections of the tubular conduit in an airtight manner. The tubular conduit may have any predetermined length dimension depending upon the number of sequentially or serially coiled or wrapped sections of the tubular conduit that are formed and fastened together, and may also have any predetermined diametrical extent depending upon, for example, the size and configuration of, for example, the mandrel around which the strip or sheet of material is coiled or wrapped. The tubular conduit can likewise be easily and rapidly deployed and stowed, and is also capable of being stored in a relatively compact state.

Obviously, many variations and modifications of the present invention are possible in light of the above teachings. It is therefore to be understood that within the scope of the appended claims, the present invention may be practiced otherwise than as specifically described herein.

1. A tubular conduit, comprising:
a strip of material having a predetermined width dimension, a longitudinal axis, and oppositely disposed, longitudinally extending side edge portions;
said strip of material being coiled into a tubular configuration along said longitudinal axis so as to form a tubular conduit comprising a plurality of coiled sections disposed adjacent to each other within a sequential array; and
fastener means extending continuously in the direction of said longitudinal axis of said strip of material for securely fastening together oppositely disposed side edge portions of adjacent coiled sections of said tubular conduit.

2. The tubular conduit as set forth in claim 1, wherein:
said fastener means are fixedly secured upon said oppositely disposed, longitudinally extending side edge portions of said strip of material.

3. The tubular conduit as set forth in claim 2, wherein:
said fastener means fixedly secured upon said oppositely disposed, longitudinally extending side edge portions of said strip of material comprises first and second type fasteners which are adapted to be mated together when said oppositely disposed side edge portions of adjacent coiled sections of said tubular conduit are to be securely fastened together.

4. The tubular conduit as set forth in claim 3, wherein:
said fastener means comprising said first and second type fasteners comprise male and female engagement fasteners.

5. The tubular conduit as set forth in claim 3, wherein:
said fastener means comprising said first and second type fasteners comprise VELCRO® type fasteners.

6. The tubular conduit as set forth in claim 3, wherein:
said fastener means comprising said first and second type fasteners comprise zipper-type fasteners.

7. The tubular conduit as set forth in claim 2, wherein:
said fastener means fixedly secured upon said oppositely disposed, longitudinally extending side edge portions of said strip of material comprises adhesive means.

8. The tubular conduit as set forth in claim 1, wherein:said fastener means extending continuously in the direction of said longitudinal axis of said strip of material for securely fastening together oppositely disposed side edge portions of adjacent coiled sections of said tubular conduit comprises stitching.

9. The tubular conduit as set forth in claim 1, wherein:
said fastener means extending continuously in the direction of said longitudinal axis of said strip of material for securely fastening together oppositely disposed side edge portions of adjacent coiled sections of said tubular conduit comprises first and second mating fasteners for effectively entrapping said oppositely disposed side edge portions of said adjacent coiled sections of said tubular conduit between said first and second mating fasteners when said first and second mating fasteners are fastened together.

10. The tubular conduit as set forth in claim 9, wherein:
said first and second mating fasteners comprise dovetail type tenon and mortise fasteners.

11. The tubular conduit as set forth in claim 10, wherein:
each one of said first and second mating fasteners comprises single dovetail type tenon and mortise fasteners.

12. The tubular conduit as set forth in claim 10, wherein:
each one of said first and second mating fasteners comprises dual dovetail type tenon and mortise fasteners.

13. The tubular conduit as set forth in claim 1, wherein:
said tubular conduit has a predetermined length dimension depending upon the number of sequentially arrayed coiled sections.

14. The tubular conduit as set forth in claim 1, wherein:
said tubular conduit has a predetermined diametrical extent depending upon the diametrical extent of each one of said plurality of sequentially arrayed coiled sections.

15. The tubular conduit as set forth in claim 14, wherein:
said tubular conduit has a constant diametrical extent.

16. The tubular conduit as set forth in claim 14, wherein:
said tubular conduit has a variable diametrical extent.

17. The tubular conduit as set forth in claim 16, wherein:
said tubular conduit has a tapered configuration.

18. The tubular conduit as set forth in claim 1, wherein:
said tubular conduit comprises a tubular fluid conduit for conducting pre-conditioned air from a source of pre-conditioned air to an aircraft ventilation system.

19. A method of forming a tubular conduit, comprising the steps of:
providing a strip of material having a predetermined width dimension, a longitudinal axis, and oppositely disposed, longitudinally extending side edge portions;
coiling said strip of material into a tubular configuration along said longitudinal axis so as to form a tubular conduit comprising a plurality of coiled sections disposed adjacent to each other within a sequential array; and
fastening together said oppositely disposed, longitudinally extending adjacent side edge portions of adjacent coiled sections of said tubular conduit.

20. The method as set forth in claim 19, further comprising the step of:
forming said tubular conduit so as to have a predetermined length dimension by forming a predetermined number of sequentially coiled sections.
